(19) United States
(12) Patent Application Publication
(10) Pub. No.: US 2013/0166185 A1
(43) Pub. Date: Jun. 27, 2013

(54) CONTROL DEVICE FOR INTERNAL COMBUSTION ENGINE

(71) Applicant: Daigo ANDO, Nagoya-shi (JP)

(72) Inventor: Daigo ANDO, Nagoya-shi (JP)

(73) Assignee: TOYOTA JIDOSHA KABUSHIKI KAISHA, Toyota-shi (JP)

(21) Appl. No.: 13/721,996

(22) Filed: Dec. 20, 2012

(30) Foreign Application Priority Data
Dec. 21, 2011 (JP) 2011-279581

(51) Int. Cl. F02D 41/04

(52) U.S. Cl. CPC F02D 41/042
USPC 701/112

(57) ABSTRACT

A control device for an internal combustion engine includes: a variable valve timing mechanism that changes a valve timing by pressure of hydraulic fluid; and a control unit that controls a change of the valve timing. The control unit sets an engine stop request-time target valve timing that is a target valve timing at the time when a request for an engine stop is issued, starts control for changing the valve timing such that the valve timing coincides with the engine stop request-time target valve timing and causes the internal combustion engine to operate at an idle at the time when the request for the engine stop is issued, starts a process of stopping the operation of the internal combustion engine at the time when the valve timing has reached a predetermined valve timing, and sets the predetermined valve timing on the basis of a temperature of the hydraulic fluid.

### INCORPORATION BY REFERENCE

The disclosure of Japanese Patent Application No. 2011-279581 filed on Dec. 21, 2012 including the specification, drawings and abstract is incorporated herein by reference in its entirety.

### BACKGROUND OF THE INVENTION

1. Field of the Invention

The invention relates to a control device for an internal combustion engine.

2. Description of Related Art

A control device for an internal combustion engine, which includes a variable valve timing mechanism that changes a valve timing, is described in, for example, Japanese Patent Application Publication No. 2007-327472 (JP 2007-327472 A). In JP 2007-327472 A, a target valve timing at the time when a request to stop the operation of the internal combustion engine (hereinafter, referred to as engine stop) is issued (hereinafter, referred to as engine stop request-time target valve timing) is set, and control for changing the valve timing such that the valve timing coincides with the engine stop request-time target valve timing (hereinafter, referred to as engine stop request-time valve timing control) is started at the time when an engine stop request is issued. In this control, a process of stopping the operation of the internal combustion engine (hereinafter, referred to as engine stop process) is started when a predetermined period of time (hereinafter, predetermined idling extension time) has elapsed from when the engine stop request is issued.

The variable valve timing mechanism (particularly, a mechanism that changes the valve timing of exhaust valves) described in JP 2007-327472 A is actuated by the pressure of hydraulic fluid. A period of time that is required to bring the valve timing into coincidence with the engine stop request-time target valve timing through engine stop request-time valve timing control (hereinafter, referred to as valve timing control time) varies depending on the temperature of hydraulic fluid. The internal combustion engine is lubricated by lubricating oil, and a period of time that is required from when the engine stop process is started to when the engine operation stops (hereinafter, referred to as engine stop time) varies depending on the temperature of the lubricating oil at the time when the engine stop request is issued. In JP 2007-327472 A, because the predetermined idling extension time is set to a constant period of time, when the valve timing control time is relatively short or when the engine stop time is relatively long, the valve timing may reach the engine stop request-time target valve timing before the engine operation is stopped. In this case, the fuel economy of the internal combustion engine may decrease by an amount by which the internal combustion engine is operated at an idle. In addition, when the valve timing control time is relatively long or when the engine stop time is relatively short, the engine operation may be stopped before the valve timing reaches the engine stop request-time target valve timing. In this case, it may be not possible to cause the valve timing to reach the engine stop request-time target valve timing.

### SUMMARY OF THE INVENTION

The invention brings a valve timing into coincidence with an engine stop request-time target valve timing at the time when the operation of an internal combustion engine is stopped and suppresses a decrease in the fuel economy of the internal combustion engine.

The invention relates to a control device for an internal combustion engine that includes a variable valve timing mechanism that changes a valve timing by pressure of hydraulic fluid. A first aspect of the invention provides a control device for an internal combustion engine. The control device includes: a control unit that controls a change of the valve timing. The control unit sets an engine stop request-time target valve timing that is a target valve timing at the time when a request for an engine stop that is a stop of operation of the internal combustion engine is issued, at the time when the request for the engine stop is issued, starts control for changing the valve timing such that the valve timing coincides with the engine stop request-time target valve timing and causes the internal combustion engine to operate at an idle, starts a process of stopping the operation of the internal combustion engine at the time when the valve timing has reached a predetermined valve timing, and sets the predetermined valve timing on the basis of a temperature of the hydraulic fluid.

With the above configuration, the predetermined valve timing is set in consideration of the temperature of hydraulic fluid, which influences the length of a valve timing control time (that is, a time that is required to bring the valve timing into coincidence with the engine stop request-time target valve timing through engine stop request-time valve timing control). Thus, it is possible to set the predetermined valve timing through engine stop request-time valve timing control such that the valve timing coincides with the engine stop request-time target valve timing and simultaneously engine operation is stopped. Therefore, it is possible to bring the valve timing into coincidence with the engine stop request-time target valve timing at the time when the operation of the internal combustion engine is stopped and to suppress a decrease in the fuel economy of the internal combustion engine.

In the control device, the control unit may set the predetermined valve timing on the basis of a temperature of lubricating oil that lubricates the internal combustion engine in addition to the temperature of the hydraulic fluid.

With the above configuration, the predetermined valve timing is set in consideration of the temperature of hydraulic fluid, which influences the length of a valve timing control time, and the temperature of lubricating oil, which influences the length of an engine stop time (that is, a time that is required from a start of an engine stop process to a stop of engine operation). Thus, it is possible to set the predetermined valve timing through engine stop request-time valve timing control such that the valve timing reliably coincides with the engine stop request-time target valve timing and simultaneously engine operation is reliably stopped. Therefore, it is possible to reliably bring the valve timing into coincidence with the engine stop request-time target valve timing at the time when the operation of the internal combustion engine is stopped and to reliably suppress a decrease in the fuel economy of the internal combustion engine.

A second aspect of the invention provides a control device for an internal combustion engine that includes a variable valve timing mechanism that changes a valve timing. The control device includes: a control unit that controls a change of the valve timing. The control unit sets an engine stop request-time target valve timing that is a target valve timing at the time when a request for an engine stop that is a stop of operation of the internal combustion engine is issued, at the time when the request for the engine stop is issued, starts control for changing the valve timing such that the valve timing coincides with the engine stop request-time target valve timing and causes the internal combustion engine to operate at an idle, starts a process of stopping the operation of the internal combustion engine at the time when the valve timing has reached a predetermined valve timing, and sets the predetermined valve timing on the basis of a temperature of lubricating oil that lubricates the internal combustion engine.

With the above configuration, the predetermined valve timing is set in consideration of the temperature of lubricating oil, which influences the length of an engine stop time (that is, a time that is required from a start of an engine stop process to a stop of engine operation). Thus, it is possible to set the predetermined valve timing through engine stop request-time valve timing control such that the valve timing coincides with the engine stop request-time target valve timing and simultaneously engine operation is stopped. Therefore, it is possible to bring the valve timing into coincidence with the engine stop request-time target valve timing at the time when the operation of the internal combustion engine is stopped and to suppress a decrease in the fuel economy of the internal combustion engine.

In the control device, a power unit may include the internal combustion engine and an electric motor, and the power unit may be able to output at least one of power of the internal combustion engine and power of the electric motor as power and may be mounted on a vehicle.

With the above configuration, the internal combustion engine is caused to operate at an idle by a period of time that is required to bring the valve timing into coincidence with the engine stop request-time target valve timing. That is, the operation of the internal combustion engine, which is not required to bring the valve timing into coincidence with the engine stop request-time target valve timing, is suppressed. Thus, it is possible to reduce the operation of the internal combustion engine as much as possible. Therefore, in the case where a mode in which the internal combustion engine is operated and the electric motor is driven and a mode in which the operation of the internal combustion engine is stopped and only the electric motor is driven (hereinafter, this mode is referred to as “intermittent mode”) are prepared, when execution of the intermittent mode in which the operation of the internal combustion engine is stopped is required, it is possible to execute the intermittent mode as early as possible.

A third aspect of the invention provides a control method for an internal combustion engine that includes a variable valve timing mechanism that changes a valve timing by pressure of hydraulic fluid. The control method includes: setting an engine stop request-time target valve timing that is a target valve timing at the time when a request for an engine stop that is a stop of operation of the internal combustion engine is issued; at the time when the request for the engine stop is issued, starting control for changing the valve timing such that the valve timing coincides with the engine stop request-time target valve timing and causing the internal combustion engine to operate at an idle; starting a process of stopping the operation of the internal combustion engine at the time when the valve timing has reached a predetermined valve timing; and setting the predetermined valve timing on the basis of a temperature of the hydraulic fluid.

A fourth aspect of the invention provides a control method for an internal combustion engine. The control method includes: setting an engine stop request-time target valve timing that is a target valve timing at the time when a request for an engine stop that is a stop of operation of the internal combustion engine is issued; at the time when the request for the engine stop is issued, starting control for changing the valve timing such that the valve timing coincides with the engine stop request-time target valve timing and causing the internal combustion engine to operate at an idle; starting a process of stopping the operation of the internal combustion engine at the time when the valve timing has reached a predetermined valve timing; and setting the predetermined valve timing on the basis of a temperature of lubricating oil that lubricates the internal combustion engine.

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a view that shows an internal combustion engine that includes a control device according to a first embodiment of the invention;

FIG. 2 is a view that shows a variable intake valve timing mechanism according to the first embodiment;

FIG. 3 is a view that shows a map that is used to acquire a target valve timing in the first embodiment;

FIG. 4 is a view that shows an example of a routine that executes engine stop control according to the first embodiment;

FIG. 5 is a time chart that shows a state of engine stop control according to the first embodiment; and

FIG. 6 is a view that shows an example of a vehicle equipped with a power unit that includes an internal combustion engine and an electric motor according to an embodiment of the invention.

### DETAILED DESCRIPTION OF EMBODIMENTS

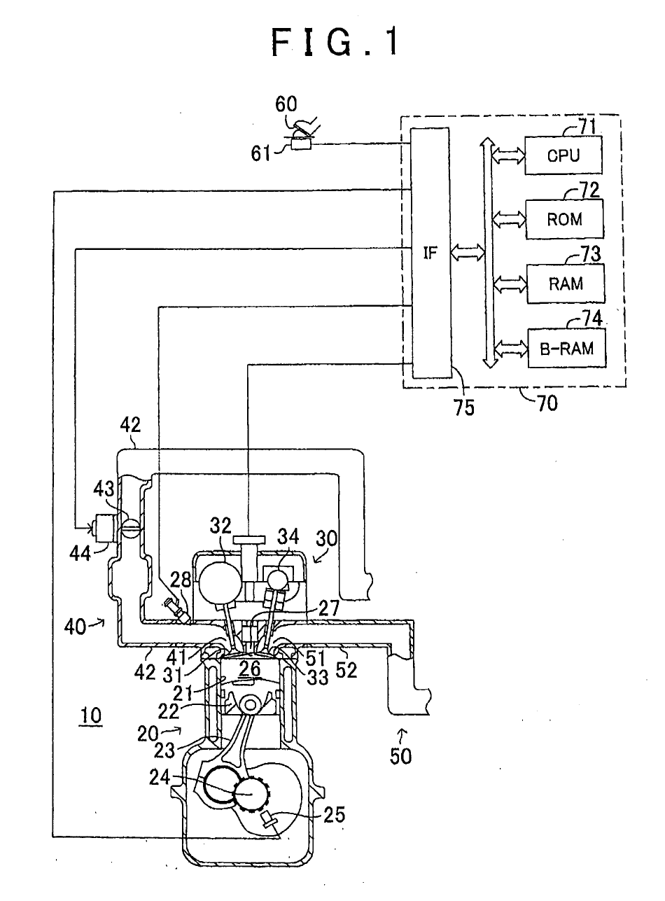

A first embodiment of the invention will be described below. FIG. 1 shows an internal combustion engine that includes a control device according to the first embodiment of the invention. In FIG. 1, the internal combustion engine 10, an internal combustion engine body 20, a valve actuating mechanism 30, an intake passage 40, an exhaust passage 50, an accelerator pedal 60 and an electronic control unit 70 are also shown in FIG. 1. A cylinder 21, a piston 22, a connecting rod 23, a crankshaft 24, a crank angle sensor 25, a combustion chamber 26, an ignition plug 27 and a fuel injection valve 28 are also shown in FIG. 1. An intake valve 31, an intake valve actuating mechanism 32, an exhaust valve 33 and an exhaust valve actuating mechanism 34 are also shown in FIG. 1. An intake port 41, an intake pipe 42, a throttle valve 43, a throttle valve actuator 44, an exhaust port 51, an exhaust pipe 52 and an accelerator pedal operation amount sensor 61 are also shown in FIG. 1.

The electronic control unit 70 includes a microprocessor (CPU) 71, a read only memory (ROM) 72, a random access memory (RAM) 73, a backup RAM (B-RAM) 74 and an interface (IF) 75. These microprocessor 71, read only memory 72, random access memory 73, backup RAM 74 and interface 75 are electrically connected to one another via a bidirectional bus.

The piston 22 is arranged in the cylinder 21 so as to be reciprocally movable within the cylinder 21. The connecting rod 23 connects the piston 22 to the crankshaft 24. The crank angle sensor 25 is attached to the internal combustion engine body (hereinafter, referred to as engine body) 20 in proximity to the crankshaft 24, and has the function of outputting an output value corresponding to the rotation phase of the crankshaft 24. The ignition plug 27 is mounted on the engine body 20 such that the distal end of the ignition plug 27 is exposed to the inside of the combustion chamber 26. The fuel injection valve 28 is mounted at the intake pipe 42 in proximity to the intake port 41.

The fuel injection valve 28 is electrically connected to the interface 75, and injects fuel into the intake port 41 on the basis of a command signal from the electronic control unit 70. Fuel injected from the fuel injection valve 28 is introduced into the combustion chamber 26 together with air via the intake port 41. The ignition plug 27 is electrically connected to the interface 75, and ignites fuel in the combustion chamber 26 on the basis of a command signal from the electronic control unit 70. The piston 22 is reciprocally moved in the cylinder 21 as fuel combusts in the combustion chamber 26. The crankshaft 24 is rotated via the connecting rod 23 as the piston 22 reciprocally moves in the cylinder 21. The crank angle sensor 25 is electrically connected to the interface 75, and the output value of the crank angle sensor 25 is input to the electronic control unit 70. The electronic control unit 70 calculates the rotation speed of the internal combustion engine on the basis of the output value of the crank angle sensor 25.

The intake valve 31 is arranged on the engine body 20, and has the function of opening or closing the intake port 41. The intake valve actuating mechanism 32 is mounted on the engine body 20. The intake valve actuating mechanism 32 opens or closes the intake valve 31, and changes the valve timing of the intake valve 31. As the intake valve 31 is opened, the intake port 41 is opened. As the intake valve 31 is closed, the intake port 41 is closed. The valve timing of the intake valve 31 means both the valve open timing of the intake valve and the valve close timing of the intake valve.

The exhaust valve 33 is arranged on the engine body 20, and has the function of opening or closing the exhaust port 51. The exhaust valve actuating mechanism 34 is mounted on the engine body 20, and has the function of opening or closing the exhaust valve 33. As the exhaust valve 33 is opened, the exhaust port 51 is opened. As the exhaust valve 33 is closed, the exhaust port 51 is closed.

The valve actuating mechanism 30 includes the intake valve 31, the intake valve actuating mechanism 32, the exhaust valve 33, and the exhaust valve actuating mechanism 34.

The intake passage 40 is formed of the intake port 41 and the intake pipe 42, and has the function of supplying air to the combustion chamber 26. The intake port 41 is formed in the engine body 20. One end of the intake pipe 42 is connected to the intake port 41, and the other end of the intake pipe 42 is open to outside air. The throttle valve 43 is pivotably arranged in the intake pipe 42, and has the function of changing the flow passage area of the intake pipe 42. The throttle valve actuator 44 is connected to the throttle valve 43.

The throttle valve actuator 44 is electrically connected to the interface 75, and actuates the throttle valve 43 such that the flow passage area of the intake pipe 42 becomes a desired flow passage area in response to a control signal that is transmitted from the electronic control unit 70.

The exhaust passage 50 is formed of the exhaust port 51 and the exhaust pipe 52, and has the function of emitting exhaust gas, which is exhausted from the combustion chamber 26, to outside air. The exhaust port 51 is formed in the engine body 20. One end of the exhaust pipe 52 is connected to the exhaust port 51, and the other end of the exhaust pipe 52 is open to outside air.

The accelerator pedal 60 is connected to the accelerator pedal operation amount sensor 61. The accelerator pedal operation amount sensor 61 has the function of outputting an output value corresponding to the depression amount of the accelerator pedal 60. The accelerator pedal operation amount sensor 61 is electrically connected to the interface 75, and the output value of the accelerator pedal operation amount sensor 61 is input to the electronic control unit 70. The electronic control unit 70 calculates a required torque (that is, a torque that is required as a torque to be output from the internal combustion engine) on the basis of the output value of the accelerator pedal operation amount sensor 61.

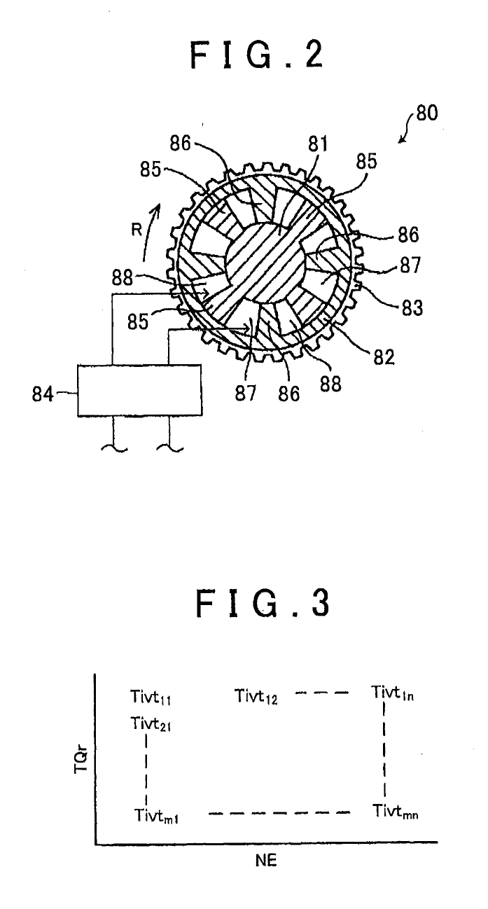

A mechanism for changing the valve timing of the intake valve in a valve actuating device according to the present embodiment (hereinafter, referred to as variable intake valve timing mechanism) will be described. The variable intake valve timing mechanism according to the present embodiment is shown in FIG. 2. In FIG. 2, the variable intake valve timing mechanism 80, an intake camshaft 81, a housing 82, a timing pulley 83 and a hydraulic actuator 84 are shown.

The housing 82 is accommodated inside the timing pulley 83 such that the outer peripheral wall surface of the housing 82 is in contact with the inner peripheral wall surface of the timing pulley 83. The timing pulley 83 is connected to the crankshaft 24 via a timing belt (not shown), and is rotated in a direction indicated by an arrow R via the timing pulley 83 through rotation of the crankshaft 24. The housing 82 is accommodated inside the timing pulley 83 so as to be non-rotatable with respect to the timing pulley 83.

A plurality of vanes 85 are provided on the outer peripheral wall surface of the intake camshaft 81. The plurality of vanes 85 extend radially outward to the inner peripheral wall surface of the housing 82. A plurality of partition walls 86 are provided on the inner peripheral wall surface of the housing 82. The plurality of partition walls 86 extend radially inward to the outer peripheral wall surface of the intake camshaft 81. A hydraulic chamber (hereinafter, referred to as advance-side hydraulic chamber) 87 is formed between each vane 85 and one of the two adjacent partition walls 86. On the other hand, a hydraulic chamber (hereinafter, referred to as a retard-side hydraulic chamber) 88 is formed between each vane 85 and the other one of the two adjacent partition walls 86.

The hydraulic actuator 84 supplies hydraulic fluid to the advance-side hydraulic chambers 87, and simultaneously drains hydraulic fluid from the retard-side hydraulic chambers 88. Alternatively, the hydraulic actuator 84 drains hydraulic fluid from the advance-side hydraulic chambers 87, and simultaneously supplies hydraulic fluid to the retard-side hydraulic chambers 88.

A cam (not shown) is provided on the intake camshaft 81, and the outer peripheral wall surface of the cam is in contact with the distal end of the intake valve 31. As the intake camshaft 81 rotates, the cam rotates. The intake valve 31 is opened or closed through the rotation of the cam. On the other hand, the exhaust valve actuating mechanism also includes an exhaust camshaft (not shown). A cam (not shown) is also provided on the exhaust camshaft. The outer periphery of the cam is in contact with the distal end of the exhaust valve 33. As the exhaust camshaft rotates, the cam rotates. The exhaust valve 33 is opened or closed through the rotation of the cam.

As the rotation of the crankshaft 24 is transmitted to the timing pulley 83 via the timing belt, the timing pulley 83 rotates. As the timing pulley 83 rotates, the housing 82 rotates together. As the housing 82 rotates, the partition walls 86 rotate together. Thus, the rotation of the housing 82 is transmitted to the vanes 85 via the advance-side hydraulic chambers 87. Then, the vanes 85 rotate, and the intake camshaft 81 rotates together with the vanes 85. By so doing, the intake valve 31 is opened or closed. As the timing pulley 83 rotates, the exhaust camshaft is also rotated. By so doing, the exhaust valve 33 is opened or closed.

As hydraulic fluid is supplied to the advance-side hydraulic chambers 87 and simultaneously hydraulic fluid is drained from the retard-side hydraulic chambers 88 by the hydraulic actuator 84, the intake camshaft 81 relatively rotates in the direction of the arrow R shown in FIG. 2 with respect to the housing 82. By so doing, the valve open timing and valve close timing of the intake valve 31 are changed to an earlier timing (that is, advanced). On the other hand, as hydraulic fluid is drained from the advance-side hydraulic chambers 87 and simultaneously hydraulic fluid is supplied to the retard-side hydraulic chambers 88 by the hydraulic actuator 84, the intake camshaft 81 relatively rotates in a direction opposite to the direction of the arrow R in FIG. 2 with respect to the housing 82. By so doing, the valve open timing and valve close timing of the intake valve 31 are changed to a later timing (that is, retarded).

In the present embodiment, an appropriate valve open timing of the intake valve is obtained in advance through an experiment, or the like, on the basis of an operating state of the internal combustion engine, which is defined by an engine rotation speed and a required torque. As shown in FIG. 3, valve open timings obtained in form of a functional map of an engine rotation speed NE and a required torque TQr are stored in the electronic control unit 70 as target valve timings Tivt. During operation of the internal combustion engine, the target valve timing Tivt corresponding to the engine rotation speed NE at that instance and the required torque at that instance are acquired. The valve open timing of the intake valve is changed by the variable intake valve timing mechanism such that the valve open timing of the intake valve coincides with the acquired target valve timing Tivt. More specifically, when the current valve open timing of the intake valve is later than the target valve timing, hydraulic fluid is supplied to the advance-side hydraulic chambers and simultaneously hydraulic fluid is drained from the retard-side hydraulic chambers by the hydraulic actuator. By so doing, the valve open timing of the intake valve is advanced toward the target valve timing. When the valve open timing of the intake valve coincides with the target valve timing, supply of hydraulic fluid to the advance-side hydraulic chambers and drain of hydraulic fluid from the retard-side hydraulic chambers by the hydraulic actuator are stopped. On the other hand, when the current valve open timing of the intake valve is earlier than the target valve timing, hydraulic fluid is drained from the advance-side hydraulic chambers and simultaneously hydraulic fluid is supplied to the retard-side hydraulic chambers by the hydraulic actuator. By so doing, the valve open timing of the intake valve is retarded toward the target valve timing. When the valve open timing of the intake valve coincides with the target valve timing, drain of hydraulic fluid from the advance-side hydraulic chambers and supply of hydraulic fluid to the retard-side hydraulic chambers by the hydraulic actuator are stopped.

In the present embodiment, when the valve open timing of the intake valve 31 is determined, the valve close timing of the intake valve 31 is uniquely determined, so a target valve timing related to the valve close timing of the intake valve 31 is not set.

Engine stop control according to the present embodiment will be described below. Engine stop control is control that is started when a request to stop engine operation is issued. In the following description, “idling operation” is “engine operation that is able to keep a minimum required engine rotation speed for maintaining engine operation”.

In the present embodiment, a target valve timing at the time when an engine stop request is issued (hereinafter, referred to as engine stop request-time target valve timing) is determined in advance. When an engine stop request is issued, the engine stop request-time target valve timing is set to the target valve timing. Control for changing the valve open timing of the intake valve such that the valve open timing of the intake valve coincides with the engine stop request-time target valve timing (hereinafter, referred to as engine stop request-time valve timing control) is started, and the internal combustion engine is caused to operate at an idle (idle operation). A process (hereinafter, referred to as engine stop process) of stopping the engine operation at the time when the valve open timing of the intake valve has reached a predetermined valve timing (hereinafter, referred to as predetermined valve timing) is started. Engine stop request-time valve timing control is executable until the engine operation stops, and is not executed when the engine operation is stopped. In the engine stop process, for example, injection of fuel from the fuel injection valve is stopped, and ignition of fuel by the ignition plug is stopped.

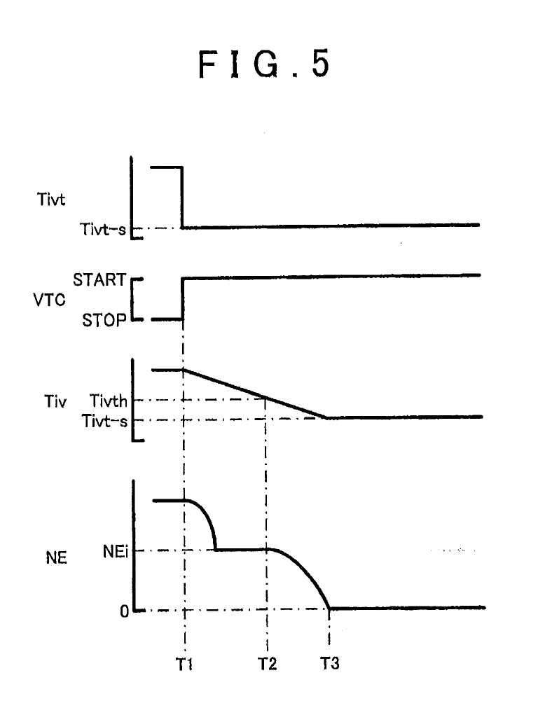

FIG. 5 shows a state of engine stop control according to the present embodiment. As shown in FIG. 5, when an engine stop request is issued at time T1, the target valve timing Tivt is set to an engine stop request-time target valve timing Tivt-s. At the same time, engine stop request-time valve timing control VTC is started, and the internal combustion engine is caused to operate at an idle, and the engine, rotation speed NE is controlled to an idling rotation speed NEi. After time T1, the valve open timing Tiv of the intake valve is gradually changed toward the engine stop request-time target valve timing Tivt-s. When the valve open timing Tiv of the intake valve has reached a predetermined valve timing Tivth at time T2, the engine stop process is started, so the engine rotation speed NE decreases. At time T3, the valve open timing Tiv of the intake valve reaches the engine stop request-time target valve timing Tivt-s, and simultaneously the engine rotation speed NE becomes zero (that is, the engine operation is stopped).

The predetermined valve timing according to the present embodiment will be described below. In the present embodiment, the predetermined valve timing is set on the basis of the temperature of hydraulic fluid that is supplied to the hydraulic chambers of the variable intake valve timing mechanism.

As described above, the variable intake valve timing mechanism according to the present embodiment changes the valve timing by the pressure of hydraulic fluid. In the present embodiment, engine operation request valve timing control is started at the time when an engine stop request is issued, and the internal combustion engine is caused to operate at an idle. The engine stop process is started at the time when the valve open timing of the intake valve has reached the predetermined valve timing, and the predetermined valve timing is set on the basis of the temperature of hydraulic fluid. That is, the predetermined valve timing is set in consideration of the temperature of hydraulic fluid, which influences the length of time that is required to cause the valve open timing of the intake valve to coincide with the engine stop request-time target valve timing through engine stop request-time valve timing control, in other words, the temperature of hydraulic fluid, which influences a rate of change in the valve open timing of the intake valve through engine stop request-time valve timing control. Thus, in the present embodiment, it is possible to set the predetermined valve timing through engine stop request-time valve timing control such that the valve open timing of the intake valve coincides with the engine stop request-time target valve timing and simultaneously the engine operation is stopped. Therefore, it is possible to bring the valve open timing of the intake valve into coincidence with the engine stop request-time target valve timing at the time when the engine operation is stopped and to suppress a decrease in the fuel economy of the internal combustion engine.

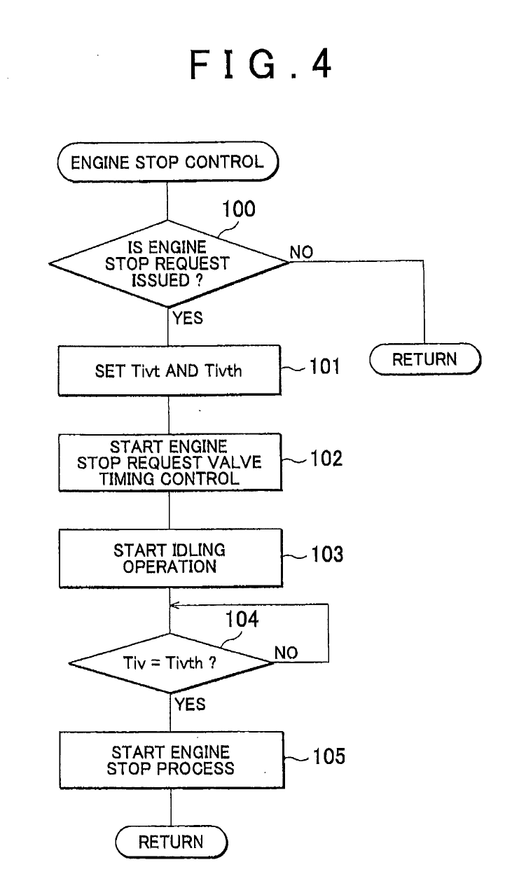

An example of a routine that executes engine stop control according to the present embodiment will be described below. An example of the routine is shown in FIG. 4. The routine is started at predetermined intervals.

As the routine shown in FIG. 4 is started, it is determined in step 100 whether an engine stop request is issued. When it is determined that an engine stop request is issued, the routine proceeds to step 101. On the other hand, when it is determined that no engine stop request is issued, the routine ends.

In step 101, the engine stop request-time target valve timing is set to the target valve timing Tivt, and the predetermined valve timing Tivth is set on the basis of the temperature of hydraulic fluid. In step 102, engine stop request-time valve timing control is started. In step 103, the idling operation of the internal combustion engine is started. In step 104, it is determined whether the valve timing of the intake valve has reached the predetermined valve timing set in step 101 (Tiv=Tivth). When it is determined that Tiv is equal to Tivth, the routine proceeds to step 105, and the engine stop process is started, after which the routine ends. On the other hand, when it is determined that Tiv is not equal to Tivth, the routine returns to step 104.

As the temperature of hydraulic fluid that is supplied to the hydraulic chambers of the variable intake valve timing mechanism increases, the rate of change in the valve timing by the variable intake valve timing mechanism increases. Thus, as the temperature of hydraulic fluid increases, a valve timing control time reduces. In the above-described embodiment, as the temperature of hydraulic fluid at the time when an engine stop request is issued increases, the predetermined valve timing is set to a valve timing that is farther from the engine stop request-time target valve timing.

In the above-described embodiment, the temperature of coolant for cooling the internal combustion engine may be employed as a parameter that represents the temperature of hydraulic fluid that is supplied to the hydraulic chambers of the variable intake valve timing mechanism.

A second embodiment of the invention will be described. In the components and controls of the second embodiment, the same components and controls as those of the first embodiment and components and controls that are naturally derived from the components and controls of the first embodiment will not be described.

In the second embodiment, as well as the first embodiment, when an engine stop request is issued, the engine stop request-time target valve timing is set to the target valve timing. Then, engine stop request-time valve timing control is started, and the internal combustion engine is caused to operate at an idle. When the valve open timing of the intake valve has reached the predetermined valve timing, the engine stop process is started. In the second embodiment, the predetermined valve timing is set on the basis of the temperature of hydraulic fluid that is supplied to the hydraulic chambers of the variable intake valve timing mechanism and the temperature of lubricating oil that lubricates the internal combustion engine.

In the present embodiment, the predetermined valve timing is set on the basis of the temperature of hydraulic fluid and the temperature of lubricating oil. That is, the predetermined valve timing is set in consideration of the temperature of hydraulic fluid, which influences the length of the valve timing control time, and the temperature of lubricating oil, which influences the length of time that is required from a start of the engine stop process to a stop of the engine operation, in other words, the temperature of lubricating oil, which influences a rate of decrease in the engine rotation speed after a start of the engine stop process. Thus, in the present embodiment, it is possible to set the predetermined valve timing through engine stop request-time valve timing control such that the valve open timing of the intake valve coincides with the engine stop request-time target valve timing and simultaneously the engine operation is stopped. Therefore, it is possible to bring the valve open timing of the intake valve into coincidence with the engine stop request-time target valve timing at the time when the engine operation is stopped and to suppress a decrease in the fuel economy of the internal combustion engine.

As the temperature of lubricating oil that lubricates the internal combustion engine increases, a friction related to the engine operation reduces. Thus, as the temperature of lubricating oil increases, the engine stop time reduces. In the present embodiment, as the temperature of lubricating oil at the time when an engine stop request is issued increases, the predetermined valve timing is set so as to be closer to the engine stop request-time target valve timing.

In the above-described embodiment, the temperature of coolant for cooling the internal combustion engine may be employed as a parameter that represents the temperature of lubricating oil that lubricates the internal combustion engine.

In the above-described embodiment, when the variable intake valve timing mechanism is not configured to change the valve timing of the intake valve by the pressure of hydraulic fluid, the predetermined valve timing may be set on the basis of the temperature of lubricating oil that lubricates the internal combustion engine.

The above-described embodiment is an embodiment in the case where the invention is applied to the internal combustion engine. The invention may also be applied to a power unit (or hybrid system) that includes an internal combustion engine and an electric motor. An example of a vehicle that includes the power unit will be described below.

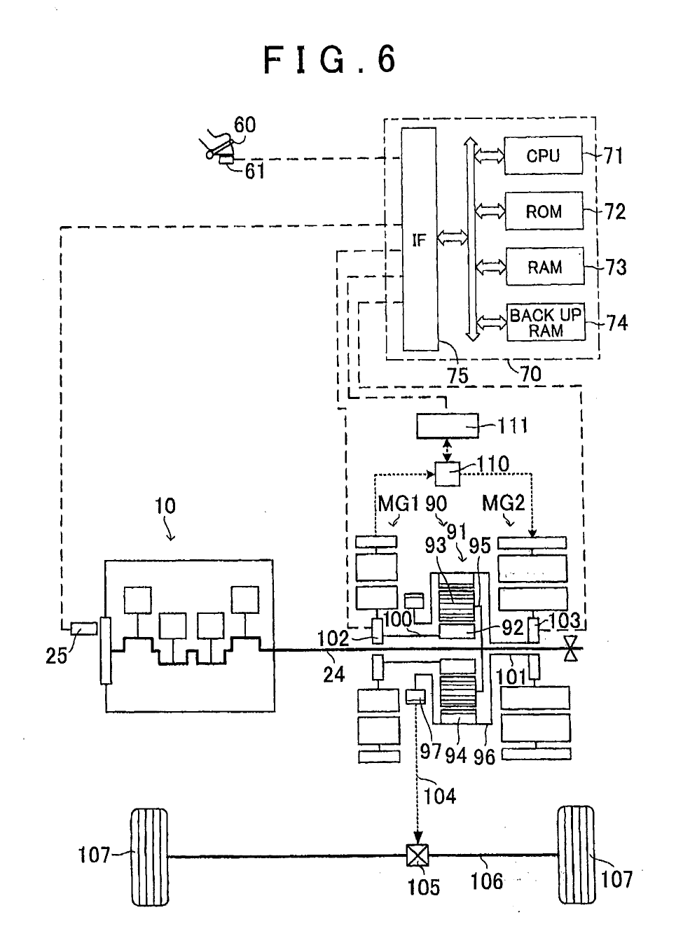

The vehicle that includes the power unit is shown in FIG. 6. In FIG. 6, motor generators MG1 and MG2 (hereinafter, referred to as first motor generator and second motor generator), the internal combustion engine 10, the crankshaft (output shaft) 24, the crank angle sensor 25, a power distribution mechanism 90, an inverter 110, a battery 111, the accelerator pedal 60, the accelerator pedal operation amount sensor 61 and the electronic control unit 70 are shown. Note that the internal combustion engine 10 shown in FIG. 6 includes the same components as those of the internal combustion engine 10 shown in FIG. 1.

The power distribution mechanism 90 includes a planetary gear unit 91. The planetary gear unit 91 includes a sun gear 92, planetary gears 93 and a ring gear 94. The planetary gears 93 are in mesh with the sun gear 92, and are in mesh with the ring gear 94. The sun gear 92 is connected to a shaft (hereinafter, referred to as first shaft) 100 of the first motor generator MG1. Thus, the first motor generator MG1 can be driven for rotation by torque that is input from the sun gear 92 to the first motor generator MG1, and is able to output torque to the sun gear 92. The first motor generator MG1 is able to generate electric power as it is driven for rotation by torque that is input from the sun gear 92 to the first motor generator MG1. The ring gear 94 is connected to a shaft (hereinafter, referred to as second shaft) 101 of the second motor generator MG2 via a ring gear carrier 96. Thus, the second motor generator MG2 is able to output torque to the ring gear 94, and can be driven for rotation by torque that is input from the ring gear 94 to the second motor generator MG2. The second motor generator MG2 is able to generate electric power as it is driven for rotation by torque that is input from the ring gear 94 to the second motor generator MG2.

The planetary gears 93 are connected to the crankshaft 24 via a planetary gear carrier 95. Thus, the planetary gears 93 are driven for rotation by torque that is input from the crankshaft 24 to the planetary gears 93. The planetary gears 93 are in mesh with the sun gear 92 and the ring gear 94. Thus, when torque is input from the planetary gears 93 to the sun gear 92, the sun gear 92 is driven for rotation by the torque. When torque is input from the planetary gears 93 to the ring gear 94, the ring gear 94 is driven for rotation by the torque. Conversely, when torque is input from the sun gear 92 to the planetary gears 93, the planetary gears 93 are driven for rotation by the torque. When torque is input from the ring gear 94 to the planetary gears 93, the planetary gears 93 are driven for rotation by the torque.

The ring gear 94 is connected to an output gear 97 via the ring gear carrier 96. Thus, the output gear 97 is driven for rotation by torque that is input from the ring gear 94 to the output gear 97, and the ring gear 94 is driven for rotation by torque that is input from the output gear 97 to the ring gear 94.

The first motor generator MG1 includes a resolver 102. The resolver 102 is connected to the interface 75 of the electronic control unit 70. The resolver 102 outputs an output value corresponding to the rotation angle of the first motor generator MG1. The output value is input to the electronic control unit 70. The electronic control unit 70 calculates the rotation speed (hereinafter, referred to as first MG rotation speed) of the first motor generator on the basis of the output value. The second motor generator MG2 includes a resolver 103. The resolver 103 is connected to the interface 75 of the electronic control unit 70. The resolver 103 outputs an output value corresponding to the rotation angle of the second motor generator. The output value is input to the electronic control unit 70. The electronic control unit 70 calculates the rotation speed (hereinafter, referred to as second MG rotation speed) of the second motor generator on the basis of the output value.

The first motor generator MG1 is electrically connected to the battery 111 via the inverter 110. Thus, when the first motor generator MG1 is generating electric power, electric power generated by the first motor generator MG1 (hereinafter, referred to as first generated electric power) can be supplied to the battery 111 via the inverter 110. The first motor generator MG1 can be driven for rotation by electric power that is supplied from the battery 111, and the rotation speed of the first motor generator MG1 is controllable by controlling a control torque (hereinafter, referred to as first control torque) that is applied to the first motor generator MG1 using electric power that is supplied from the battery 111.

The second motor generator MG2 is electrically connected to the battery 111 via the inverter 110. The second motor generator MG2 can be driven, for rotation by electric power that is supplied from the battery 111, and the rotation speed of the second motor generator MG2 is controllable by controlling a control torque (hereinafter, referred to as second control torque) that is applied to the second motor generator MG2 using electric power that is supplied from the battery 111. When the second motor generator MG2 is generating electric power, electric power generated by the second motor generator MG2 (hereinafter, referred to as second generated electric power) can be supplied to the battery 111 via the inverter 110. The first generated electric power can be directly supplied to the second motor generator MG2, and the second generated electric power can be directly supplied to the first motor generator MG1.

The battery 111 is connected to the interface 75 of the electronic control unit 70. Information about the amount of electric power that is stored in the battery 111 is input to the interface 75 of the electronic control unit 70. Although not shown in the drawing, the inverter 110 is connected to the interface 75 of the electronic control unit 70. The amount of electric power that is supplied from the inverter 110 to the second motor generator MG2 and the amount of electric power that is supplied from the inverter 110 to the first motor generator MG1 are controlled by a command that is transmitted from the electronic control unit 70 via the interface 75.

The output gear 97 is connected to a differential gear 105 via a gear train 104. The differential gear 105 is connected to a drive shaft 106. Drive wheels 107 are respectively connected to both ends of the drive shaft 106. Thus, torque from the output gear 97 is transmitted to the drive wheels 107 via the gear train 104, the differential gear 105 and the drive shaft 106.

In the power unit, a required power that is required for the power unit is calculated on the basis of the accelerator pedal operation amount and the vehicle speed. The power unit is formed of the internal combustion engine 10, the first motor generator MG1 and the second motor generator MG2.

In the power unit, a power that is output from the internal combustion engine within the required power is calculated as a required engine power. An engine operation point at which fuel economy is maximum when the required engine power is caused to output from the crankshaft is obtained in advance by an experiment, or the like, as an optimal engine operation point for each required engine power. These optimal engine operation points are plotted on a graph that is defined by an engine torque and an engine rotation speed, and these optimal engine operation points are connected. The thus formed line is obtained as an optimal engine operation line. The optimal engine operation line is stored in the electronic control unit. A required engine power is calculated during engine operation, and an engine operation point in the optimal engine operation line, at which it is possible to output the calculated required engine power from the internal combustion engine, is selected. The engine torque and the engine rotation speed that define the selected engine operation point are respectively set for a target engine torque and a target engine rotation speed. The fuel injection amount and the engine rotation speed are controlled such that the set target engine torque and target engine rotation speed are achieved.

When the required engine power calculated during engine operation is zero, the engine operation is stopped, and the required power is output from the power unit using only power from the first motor generator or the second motor generator or both of the first motor generator and the second motor generator.

When the second MG rotation speed is constant, as the first MG rotation speed changes, the engine rotation speed also changes. In other words, it is possible to control the engine rotation speed by controlling the first MG rotation speed. Where the first MG rotation speed is denoted by NM1, the second MG rotation speed is denoted by NM2, the engine rotation speed is denoted by NE and the ratio of the number of teeth of the sun gear to the number of teeth of the ring gear (that is, the number of teeth of the sun gear/the number of teeth of the ring gear) is denoted by ρ, the relationship expressed by the following mathematical expression (1) holds between the first MG rotation speed and the engine rotation speed. Where the target first MG rotation speed is denoted by NM1t and the target engine rotation speed is denoted by NEt, the relationship expressed by the following mathematical expression (2) holds between the target first MG rotation speed and the target engine rotation speed.

NM1=(NE−NM2)/ρ+NE (1)

NM1t=(NEt−NM2)/ρ+NEt (2)

In the power unit, the target first MG rotation speed NM1t is calculated from the above mathematical expression (2) using the target engine rotation speed NEt, which is set in accordance with the engine operation point that is selected in accordance with the required output, and the current second MG rotation speed NM2. A deviation (=NM1t−NM1) of the current first MG rotation speed NM1 with respect to the calculated target first MG rotation speed NM1t is calculated. The first control torque is controlled such that the calculated deviation becomes zero.

Where an engine torque is denoted by TQE, an engine torque that is input to the ring gear (or the drive wheels) (hereinafter, referred to as ring gear input engine torque) is denoted by TQEr and the ratio of the number of teeth of the sun gear to the number of teeth of the ring gear (that is, the number of teeth of the sun gear/the number of teeth of the ring gear) is denoted by ρ, the relationship expressed by the following mathematical expression (3) holds between the ring gear input engine torque and the engine torque.

TQEr=1/(1+ρ)×TQE (3)

That is, the ring gear input engine torque TQEr is part of the, engine torque TQE. Thus, the ring gear input engine torque TQEr is smaller than the required driving torque (that is, torque that should be input to the drive wheels 107). In the present embodiment, the second control torque is controlled such, that a torque corresponding to the difference between the required driving torque and the ring gear input engine torque TQEr is input from the second motor generator to the ring gear, and a torque equal to the required driving torque is input to the ring gear.

When the invention is applied to the power unit or the internal combustion engine of the vehicle that includes power unit, the internal combustion engine is caused to operate at an idle by a period of time that is required to bring the valve timing into coincidence with the engine stop request-time target valve timing. That is, engine operation that is not required to bring the valve timing into coincidence with the engine stop request-time target valve timing is suppressed. Thus, it is possible to reduce the engine operation as much as possible. Therefore, in the case where a mode in which the internal combustion engine is operated and the first motor generator (or the second motor generator or both the first motor generator and the second motor generator) is driven and a mode in which the engine operation is stopped and only the first motor generator (or the second motor generator or both the first motor generator and the second motor generator) is driven (hereinafter, referred to as intermittent mode) are prepared, when execution of the intermittent mode in which the engine operation is stopped is required, it is possible to execute the intermittent mode as early as possible.

The above-described embodiment is an embodiment in the case where the invention is applied to the internal combustion engine that includes the variable intake valve timing mechanism that changes the valve open timing and valve close timing of the intake valve. The invention is also applicable to an internal combustion engine that includes a variable intake valve timing mechanism that changes one of the valve open timing of the intake valve and the valve'close timing of the intake valve.

The above-described embodiment is an embodiment in the case where the invention is applied to the internal combustion engine that includes the variable intake valve timing mechanism that changes the valve timing of the intake valve. The invention is also applicable to an internal combustion engine that includes a variable exhaust valve timing mechanism that changes the valve timing of the exhaust valve instead of the variable intake valve timing mechanism. In this case, the exhaust valve actuating mechanism has the function of opening or closing the exhaust valve and the function of changing the valve timing of the exhaust valve. In this case, the same configuration as the configuration of the variable intake valve timing mechanism described with reference to FIG. 2 may be, for example, employed as the configuration of the variable exhaust valve timing mechanism.

The above-described embodiment is an embodiment in the case where the invention is applied to a spark ignition internal combustion engine (so-called gasoline engine). The invention is also applicable to a compression ignition internal combustion engine (so-called diesel engine).

What is claimed is:

1. A control device for an internal combustion engine that includes a variable valve timing mechanism that changes a valve timing by pressure of hydraulic fluid, the control device comprising:
a control unit that controls a change of the valve timing, wherein
the control unit sets an engine stop request-time target valve timing that is a target valve timing at the time when a request for an engine stop that is a stop of operation of the internal combustion engine is issued,
at the time when the request for the engine stop is issued, the control unit starts control for changing the valve timing such that the valve timing coincides with the engine stop request-time target valve timing and causes the internal combustion engine to operate at an idle,
the control unit starts a process of stopping the operation of the internal combustion engine at the time when the valve timing has reached a predetermined valve timing, and the control unit sets the predetermined valve timing on the basis of a temperature of the hydraulic fluid.

2. The control device according to claim 1, wherein
the control unit sets the predetermined valve timing on the basis of a temperature of lubricating oil that lubricates the internal combustion engine in addition to the temperature of the hydraulic fluid.

3. The control device according to claim 2, wherein
a power unit includes the internal combustion engine and an electric motor, and
the power unit is able to output at least one of power of the internal combustion engine and power of the electric motor as power and is mounted on a vehicle.

4. A control device for an internal combustion engine that includes a variable valve timing mechanism that changes a valve timing, the control device comprising:
a control unit that controls a change of the valve timing, wherein
the control unit sets an engine stop request-time target valve timing that is a target valve timing at the time when a request for an engine stop that is a stop of operation of the internal combustion engine is issued,
at the time when the request for the engine stop is issued, the control unit starts control for changing the valve timing such that the valve timing coincides with the engine stop request-time target valve timing and causes the internal combustion engine to operate at an idle,
the control unit starts a process of stopping the operation of the internal combustion engine at the time when the valve timing has reached a predetermined valve timing, and the control unit sets the predetermined valve timing on the basis of a temperature of lubricating oil that lubricates the internal combustion engine.

5. The control device according to claim 4, wherein
a power unit includes the internal combustion engine and an electric motor, and
the power unit is able to output at least one of power of the internal combustion engine and power of the electric motor as power and is mounted on a vehicle.

6. A control method for an internal combustion engine that includes a variable valve timing mechanism that changes a valve timing by pressure of hydraulic fluid, the control method comprising:
setting an engine stop request-time target valve timing that is a target valve timing at the time when a request for an engine stop that is a stop of operation of the internal combustion engine is issued;
at the time when the request for the engine stop is issued, starting control for changing the valve timing such that the valve timing coincides with the engine stop request-time target valve timing and causing the internal combustion engine to operate at an idle;
starting a process of stopping the operation of the internal combustion engine at the time when the valve timing has reached a predetermined valve timing; and
setting the predetermined valve timing on the basis of a temperature of the hydraulic fluid.

7. A control method for an internal combustion engine, comprising:
setting an engine stop request-time target valve timing that is a target valve timing at the time when a request for an engine stop that is a stop of operation of the internal combustion engine is issued;
at the time when the request for the engine stop is issued, starting control for changing the valve timing such that the valve timing coincides with the engine stop request-time target valve timing and causing the internal combustion engine to operate at an idle;
starting a process of stopping the operation of the internal combustion engine at the time when the valve timing has reached a predetermined valve timing, and
setting the predetermined valve timing on the basis of a temperature of lubricating oil that lubricates the internal combustion engine.
